(19) United States
(12) Patent Application Publication
(10) Pub. No.: US 2008/0006360 A1
(43) Pub. Date: Jan. 10, 2008

(54) PNEUMATIC VEHICLE TIRE WITH BEAD REINFORCER

(75) Inventors: Hans-Bernd KORTE, Wunstorf (DE); Martin Josef KRAUS, Hannover (DE); Heinz-Bernhard MAZUR, Wedemark (DE)

Correspondence Address: GREENBLUM & BERNSTEIN, P.L.C., 1950 ROLAND CLARKE PLACE, RESTON, VA, 20191, US

(73) Assignee: CONTINENTAL AKTIENGESELLSCHAFT, Hannover (DE)

(21) Appl. No.: 11/773,002

(22) Filed: Jul. 3, 2007

Related U.S. Application Data
(63) Continuation of application No. PCT/EP05/12943, filed on Dec. 2, 2005.

(30) Foreign Application Priority Data
Jan. 4, 2005 (DE) 10 2005 000 755.4

(51) Int. Cl. B60C 15/05; B29D 30/32

(52) U.S. Cl. 152/540; 152/545; 156/135

(57) ABSTRACT

A pneumatic vehicle tire includes a tread and two tire side walls each having one tire bead which is formed at a radially inner end. A carcass starts from the tread and extending on both sides of the tread, the carcass comprises a main part through the tire side walls in a radially inner direction to a tire bead and is folded over in the tire bead about a bead core formed so as to extend over a circumference of the pneumatic vehicle tire in order to secure a seat of the pneumatic vehicle tire on a rim, and extends radially outward with the fold in the carcass. A first bead reinforcement material is arranged on a side of the bead core axially facing the main part of the carcass between the main part of the carcass and the bead core. A second bead reinforcement material is arranged on a side of the bead core axially facing the fold in the carcass between the fold in the carcass and the bead core. The first and the second bead reinforcement materials have strength members continuously wound in a helical shape from radially on an inside to radially on an outside in a circumferential direction and in opposing winding directions. A method of manufacturing the pneumatic tire is also provided.

### CROSS-REFERENCE TO RELATED APPLICATIONS

The present application is a Continuation of International Patent Application No. PCT/EP2005/012943 filed on Dec. 5, 2005 and claims priority under 35 U.S.C. §119 of German Patent Application No. 10 2005 000 755.4, filed Jan. 4, 2005. Moreover, the disclosures of International Patent Application No. PCT/EP2005/012943 and German Patent Application No. 10 2005 000 755.4 are expressly incorporated by reference herein in their entirety.

### BACKGROUND OF THE INVENTION

1. Field of the Invention

The invention relates to a pneumatic vehicle tire having a tread with two tire side walls and with bead reinforcement material with strength members wound in opposing directions.

2. Discussion of Background Information

Manufacture of tires for vehicle wheels includes the formation of a carcass structure. The carcass structure consists of one or more carcass plies substantially having a toroidal conformation with the axially opposite side edges engaging respective circumferentially annular reinforcing elements called bead cores.

A belt is applied to the carcass structure, at a circumferentially external position thereof. The belt comprises one or more belt strips in a closed ring. The belt typically includes textile or metal cords.

A tread band of elastomer material is applied to the belt, at a circumferentially external position thereof. Finally, a pair of sidewalls is applied to the opposite sides of the tire. The sidewalls cover a side portion of the tire included between a shoulder region, and a bead located at the corresponding bead core.

### SUMMARY OF THE INVENTION

The invention is based on easily forming the bead region with a high circumferential rigidity accompanied by uniform application force from the carcass into the bead. This is achieved according to the invention by having a tread, having two tire side walls and in each case one tire bead which is formed at the radially inner end of a tire side wall. A carcass starts from the tread and extends on both sides of the tread with a main part of the carcass through the tire side wall in the radially inner direction to the tire bead. The carcass is folded over in the tire bead about a bead core which is formed so as to extend over the circumference of the pneumatic vehicle tire in order to secure the seat of the pneumatic vehicle tire on a correspondingly embodied rim, and extends radially outward with the fold in the carcass. A first bead reinforcement material is arranged on the side of the bead core axially facing the main part of the carcass, in particular between the main part of the carcass and the bead core. A second bead reinforcement material is arranged on the side of the bead core axially facing the fold in the carcass, in particular between the fold in the carcass and the bead core. Both the first and the second bead reinforcement materials have strength members which are continuously wound in a helical shape from radially on the inside to radially on the outside in the circumferential direction. The two strength members have opposing winding directions.

As a result, the bead core is enclosed in the bead region in a sandwich like manner on both sides by bead reinforcement material oriented in the circumferential direction. This permits high circumferential rigidity and, by virtue of the helical winding in opposite directions, a very uniform transmission of force from the carcass into the bead core and from the bead core into the carcass over the entire circumference, in both circumferential directions. The opposed winding directions of the two bead reinforcement materials also has the effect of limiting the bead regions so that force can be applied very uniformly into the bead region which is enclosed by bead reinforcement materials. Also, the risk of high local loading peaks in the bead region which is enclosed by the bead reinforcement materials can be minimized. As a result, the demands made of the loadability of the materials which are enclosed between the bead reinforcement materials in the bead region are reduced so that a relatively large number of materials can be used. This permits a greater variety of individual designs and configurations of the bead region and thus a wider design spectrum of the pneumatic vehicle tires.

A core rider is arranged on the radial outer side of the bead core and is formed so as to extend in the circumferential direction of the pneumatic vehicle tire over the entire circumference of the pneumatic vehicle tire. The first bead reinforcement material is formed axially between the main part of the carcass and the core rider from the bead core in the radially outer direction along the surface of the core rider, and/or the second bead reinforcement material is formed so as to extend axially between the fold in the carcass and the core rider from the bead core in the radially outer direction along the surface of the core rider. This arrangement permits very close and circumferentially rigid binding to the bead core and core rider with a very uniform application of force and distribution of load into the bead core and the bead rider. The risk of undesirably high load peaks in the bead core and bead rider can be reduced as a result of this arrangement.

In order to improve the durability of the tire in the bead region it is preferred to embody a pneumatic vehicle tire where the fold in the carcass ends in the radially outer direction in the radial region of the extension of the core rider. It is particularly advantageous to embody a pneumatic vehicle tire with a carcass of a radial design. As a result the durability of the tire in the bead region can be further improved.

The carcass has strength members made of steel. As a result, the durability of the tire in the bead region can be further improved.

The bead reinforcement material has strength members made of steel. As a result, the durability of the tire in the bead region can be further improved,

The strength members of the bead reinforcement material are strength members which are wound directly onto the surface of the bead core and/or of the bead core rider, which easily permits particularly close and circumferentially rigid binding to the bead core and core rider with very uniform application of force and load distribution into the bead core and the bead rider. The risk of undesirably high load peaks in the bead core and bead rider can be reduced as a result of this arrangement. The bead core, core rider and bead reinforcement material can be constructed in advance to form a module component and can be installed as a prefabricated component when the tire is constructed.

The strength member, which is continuously wound in a helical shape from radially inward to radially outward in the circumferential direction, of the first bead reinforcement material of a first and second bead of the pneumatic vehicle tire has the same winding direction. In each case, the strength member, which is continuously wound in a helical shape from radially inward to radially outward in the circumferential direction, of the second bead reinforcement material of the first and second beads of the pneumatic vehicle tire has the same winding direction. This symmetrical embodiment in the pneumatic vehicle tire is advantageous, in particular, with regard to the wear behavior of the profile in the pneumatic vehicle tires with a profile which is related to the direction of travel. Furthermore, damage phenomena on the bead region of pneumatic vehicle tires with such a symmetrical embodiment can be positively influenced.

In further embodiments, the helical shape from radially inward to radially outward in the circumferential direction. A first bead reinforcement material of the first bead and the strength member of the second bead reinforcement material of the second bead have the same winding direction. The strength member of the second bead reinforcement material of the first bead and the strength member of the first bead reinforcement material of the second bead have the same winding direction. This asymmetrical embodiment in the pneumatic vehicle tire permits very simple manufacture with identical, prefabricated bead cores for both beads.

In an aspect of the invention, the pneumatic vehicle tire comprises a tread and two tire side walls each having one tire bead which is formed at a radially inner end. A carcass starts from the tread and extends on both sides of the tread. The carcass comprises a main part through the tire side walls in a radially inner direction to a tire bead and folded over in the tire bead about a bead core formed so as to extend over a circumference of the pneumatic vehicle tire in order to secure a seat of the pneumatic vehicle tire on a rim, and extend radially outward with the fold in the carcass. A first bead reinforcement material is arranged on a side of the bead core axially facing the main part of the carcass between the main part of the carcass and the bead core. A second bead reinforcement material is arranged on a side of the bead core axially facing the fold in the carcass between the fold in the carcass and the bead core. The first and the second bead reinforcement materials have strength members continuously wound in a helical shape from radially on an inside to radially on an outside in a circumferential direction and in opposing winding directions.

In embodiments, a core rider is arranged on a radial outer side of the bead core and formed so as to extend in the circumferential direction of the pneumatic vehicle tire over an entire circumference of the pneumatic vehicle tire. The first bead reinforcement material is formed axially between the main part of the carcass and the core rider from the bead core in the radially outer direction along a surface of the core rider; and/or the second bead reinforcement material is formed so as to extend axially between the fold in the carcass and the core rider from the bead core in the radially outer direction along the surface of the core rider.

The fold in the carcass ends in the radially outer direction in a radial region of an extension of the core rider. The carcass is of a radial design. The carcass includes steel strength members. The strength members of the first and second bead reinforcement material are steel. The strength members of the first and second bead reinforcement material are wound directly onto a surface of at least one of the bead core and of the core rider. The strength member of the first bead reinforcement material of a first and second bead of the tire side walls have a same winding direction, and the strength member of the second bead reinforcement material of the first and second bead have a same winding direction. The strength member of the first bead reinforcement material of a first bead of the tire side walls and the strength member of the second bead reinforcement material of a second bead of the tire side walls have a same winding direction. The strength member of the second bead reinforcement material of the first bead and the strength member of the first bead reinforcement material of the second bead of the pneumatic vehicle tire have a same winding direction.

In another aspect of the invention, pneumatic vehicle tire comprises a first bead reinforcement material arranged on an inner side of a bead core and a second bead reinforcement material on an outer side of the bead core. The first and the second bead reinforcement materials have strength members continuously wound in a helical shape from radially on an inside to radially on an outside in a circumferential direction and in opposing winding directions.

The first bead reinforcement material and the second bead reinforcement material extend over an entire circumference of the pneumatic vehicle tire. The first bead reinforcement material is formed axially between a main part of a carcass and a bead core with a bead filler. The strength members are metallic embedded in rubber and constructed from one of a monofilament and a multifilament. The first and second bead reinforcement material rest directly on a surface of the bead filler and of the bead core and the second bead reinforcement material is formed axially between a fold in the carcass and the bead core with the bead filler.

The first bead reinforcement material extends starting from a radial position which corresponds to the radially outermost extension of the bead core, outward in the radial direction as far as at maximum over an entire extension of a side wall in an outward direction, and inward in the radial direction as far as at maximum over an entire extension of the side wall in the inward direction. The second bead reinforcement tire extends outward in the radial direction starting from the radial position, corresponding to the radially outermost extension of the bead core, in the radial direction as far as at maximum over the entire extension of the side wall in the outward direction, and inward in the radial direction as far as at maximum over the entire extension of the side wall in the inward direction. The winding direction viewed frown radially inward to radially outward of the strength member of the first bead reinforcement material is selected in an opposite circumferential direction to a winding direction of the strength member of the second bead reinforcement material.

The winding direction of the strength member of the second bead reinforcement material is wound from radially inward to radially outward counter to a circumferential direction “U” which is in a rotational direction when a vehicle is traveling forward with a mounted vehicle pneumatic tire. The winding direction of the strength member of the first bead reinforcement material is wound radially inward to radially outward in the circumferential direction “Up which is in the rotational direction when the vehicle is traveling forward.

The winding direction of the strength member of the first bead reinforcement strip is wound from radially inward to radially outward counter to a circumferential direction “U” which is in a rotational direction when a vehicle is traveling forward with a vehicle pneumatic tire mounted. The winding direction of the strength member of the second bead reinforcement strip is wound from radially inward to radially outward in the circumferential direction “U” which is in the rotational direction when the vehicle traveling forward.

A method of manufacturing pneumatic a vehicle tire comprises continuously winding strength members of a first bead reinforcement material on a side of a bead core axially facing a main part of a carcass and between the main part of the carcass and the bead core in a helical shape from radially on an inside to radially on an outside in a circumferential direction in a first direction. The method further comprises continuously winding strength members of a second bead reinforcement material arranged on a side of the bead core axially facing a fold in the carcass and between the fold in the carcass and the bead core in a helical shape from radially on an inside to radially on an outside in a circumferential direction and in an opposing direction to the first direction.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein,

FIG. 1 is a schematic cross-sectional illustration of a pneumatic vehicle tire showing the structure of the tire in a sectional plane which includes the rotational axis of the pneumatic vehicle tire;

FIG. 2 shows a sectional illustration of the pneumatic vehicle tire from FIG. 1 along the sectional line II-II, showing the winding direction of the first bead reinforcer;

FIG. 3 is a sectional illustration of the pneumatic vehicle tire from FIG. 1 along the sectional line III-III showing the winding direction of the second bead reinforcer;

FIG. 4 is a perspective sectional Illustration of the right-hand bead core which is shown in FIG. 1 and which has two bead reinforcers in a first embodiment;

FIG. 5 shows a perspective sectional illustration of the right hand bead core which is shown in FIG. 1 and which has two bead reinforcers in a second embodiment,

FIG. 6 is a schematic illustration of the two bead regions of the pneumatic vehicle tire in a first symmetrical embodiment;

FIG. 7 is a schematic illustration of the two bead regions of the pneumatic vehicle tire in a second symmetrical embodiment,

FIG. 8 is a schematic illustration of the two bead regions of the pneumatic vehicle tire in a first asymmetrical embodiment; and

FIG. 9 is a schematic illustration of the two bead regions of the pneumatic vehicle tire in a second asymmetrical embodiment.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

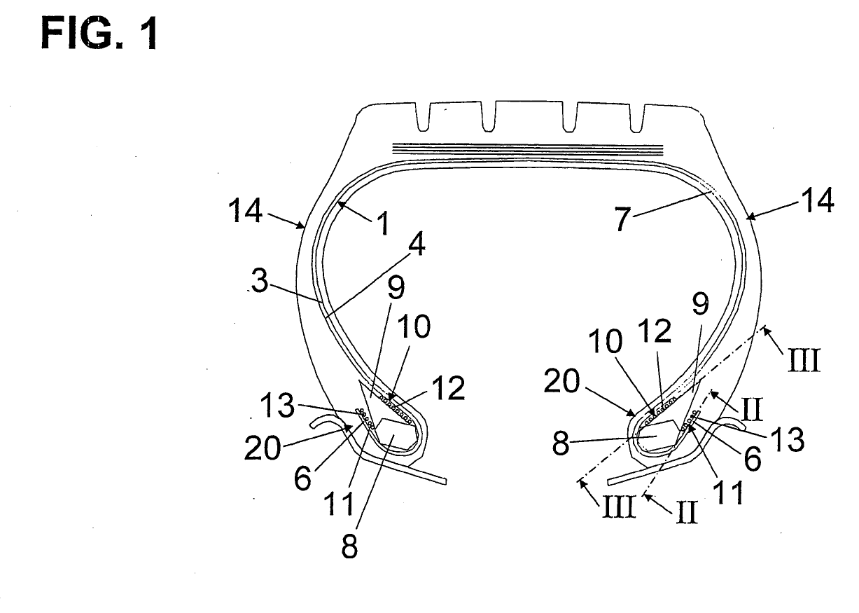

FIG. 1 shows a utility vehicle pneumatic tire having a tread 15 and two tire side walls 14 which each extend radially inward starting from the tread 15. The utility vehicle pneumatic tire includes a tire bead 20 which extends over the circumference of the tire at the radially inner end of the tire side walls 14. The tire bead 20 has an annular bead core 8 which is embodied in the tire bead 20 concentrically with respect to the pneumatic vehicle tire.

The utility vehicle pneumatic tire has an inner ply 2 made of a rubber material of a known type which is relatively impermeable to air. The inner ply 2 extends axially from the one bead core 8 to the other bead core 8 and in the circumferential direction over the entire circumference of the tire.

A carcass 1 made of two carcass plies 3 and 4 of a radial design is constructed radially over the inner ply 2. The carcass plies 3 and 4 extend over the entire circumference of the tire and in the axial direction with a main part 7 of the carcass from the one bead core 8 to the other bead core 8. The carcass plies 3 and 4 extend from radially inside the bead core 8 and radially underneath the bead core 8 in an axially outer direction. The carcass plies 3 and 4 are, in each case, folded over in the radially upward direction about the bead core 8 axially outside the bead cores 8 so that the carcass plies 3 and 4 each form a fold 6 in the carcass axially outside the bead cores 8. The fold 6 runs parallel to the bead core 8 and to a bead filler 9 which is formed radially above the bead core 8. The fold 6 ends in the radial region of extension of the bead filler 9. In embodiments, the carcass plies 3 and 4 are each formed from parallel metallic strength members, made from steel for example, which are embedded in rubber.

A belt 5 has four belt plies 16, 17, 18, 19. The four belt plies 16, 17, 18, 19 are constructed one on top of the other and each extend over the circumference of the tire in the axial direction from one tire shoulder to the next. The four belt plies 16, 17, 18, 19 are also formed between the carcass 1 and the profiled tread 15. The belt plies 16, 17, 18, 19 are each formed from parallel metallic strength members, made from steel, for example, which are embedded in rubber.

The strength members of the first belt ply 16 are embodied so as to extend in the equator level at an acute angle of less than or equal to 50°, for example of 20°, with respect to the circumferential direction. The strength members of the second belt ply 17 are embodied so as to extend in the equator level at an acute angle of less than or equal to 50°, for example of 20°, with respect to the circumferential direction. The strength members of the third belt ply 18 are embodied so as to extend in the equator level at an acute angle of less than or equal to 50°, for example of 20°, with respect to the circumferential direction. The strength members of the fourth belt ply 19 are embodied so as to extend in the equator level at an acute angle of less than or equal to 50°, for example of 20°, with respect to the circumferential direction.

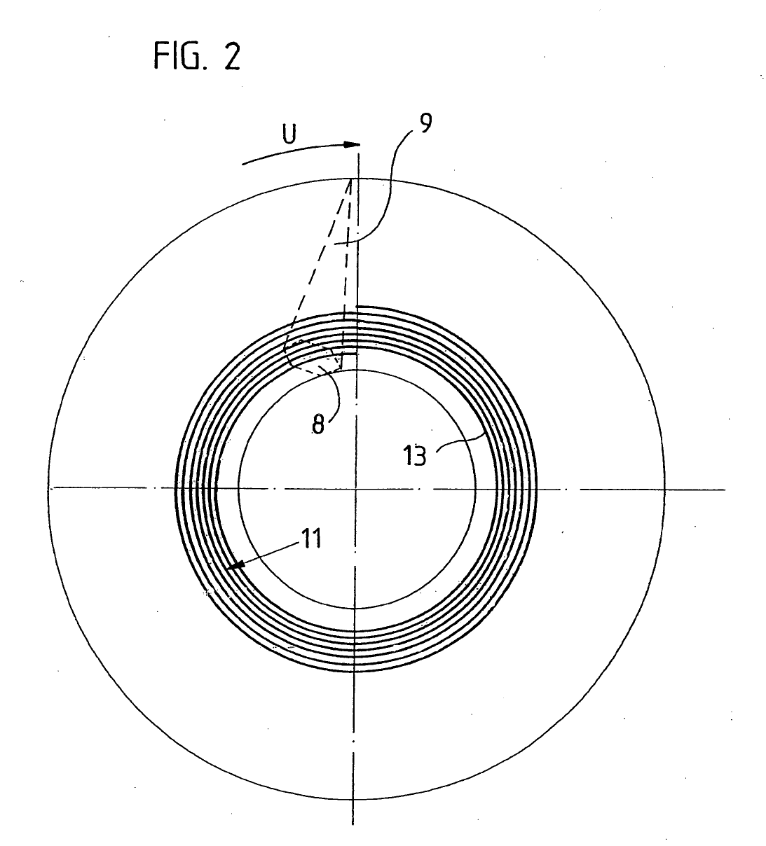

A first bead reinforcement strip 10 extends over the entire circumference of the tire. The first bead reinforcement strip 10 is formed axially between the main part 7 of the carcass and the bead core 8 with the bead filler 9. The bead reinforcement strip 10 is constructed from a strength member 12 which is wound continuously in a helical shape from radially inward to radially outward in the circumferential direction, as is shown in FIG. 2. The strength member 12 is a metallic strength member 12 which is embedded in rubber and which is constructed, for example, from a monofilament or from a multifilament. The strength member is, for example, a steel cord.

The bead reinforcement strip 10 rests directly on the surface of the bead filler 9 and of the bead core 8 and extends outward in the radial direction starting from a radial position, corresponding to the radially outermost extension of the bead core 8. The extension can be as far as a radial position 50 mm to 70 mm radially outside the radially outermost extension of the bead core 8, and inward in the radial direction as far as a radial position 50 to 70 mm radially inside the radially outermost extension of the bead core 8.

In one embodiment, the bead reinforcement strip 10 extends from the radial position which corresponds to the radially outermost extension of the bead core 8, outward in the radial direction as far as at maximum over the entire extension of the side wall in the outward direction, and inward in the radial direction as far as at maximum over the entire extension of the side wall in the inward direction.

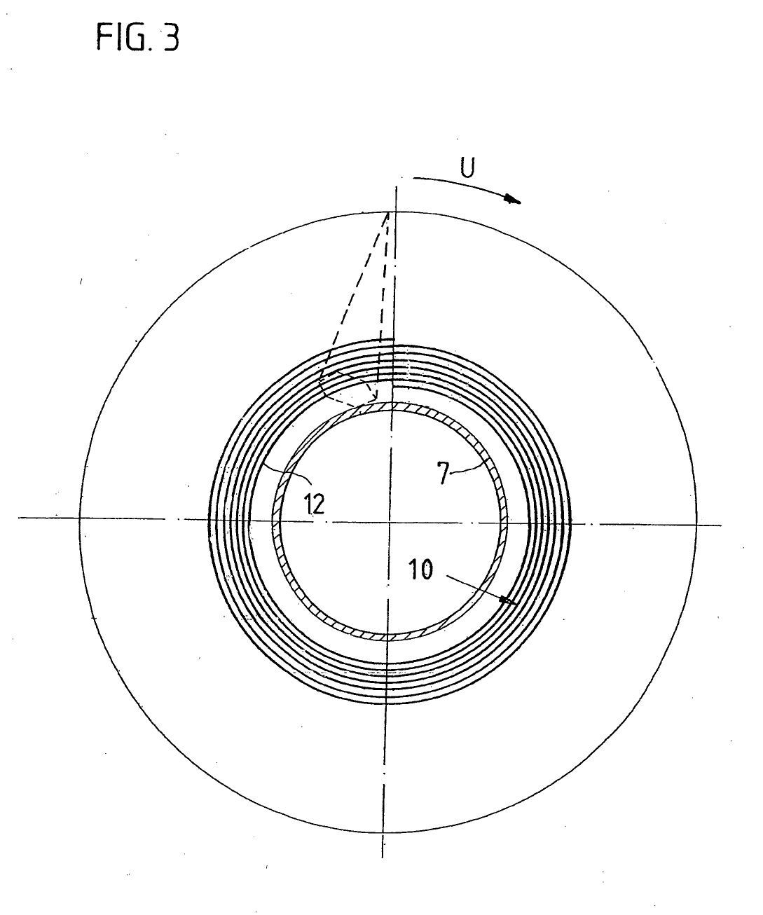

A second bead reinforcement strip 11 extends over the entire circumference of the tire. The second bead reinforcement strip 11 is formed axially between the fold 6 in the carcass and the bead core 8 with the bead filler 9. The bead reinforcement strip 11 is constructed from a strength member 13 which is wound continuously in a helical shape from radially inward to radially outward in the circumferential direction, as is shown in FIG. 3. The strength member 13 is a metallic strength member 13 which is embedded in rubber and which is constructed, for example, from a monofilament or from a multifilament. The strength member is, for example, a steel cord.

The bead reinforcement strip 11 rests directly on the surface of the bead filler 9 and of the bead core 8 and extends outward in the radial direction starting from a radial position, corresponding to the radially outermost extension of the bead core 8. The extension is as far as a radial position 50 mm to 70 mm radially outside the radially outermost extension of the bead core 8, and inward in the radial direction as far as a radial position 50 to 70 mm radially inside the radially outermost extension of the bead core 8.

In an embodiment, the bead reinforcement tire 11 extends outward in the radial direction from the radial position, corresponding to the radially outermost extension of the bead core 8, in the radial direction as far as at maximum over the entire extension of the side wall in the outward direction, and inward in the radial direction as far as at maximum over the entire extension of the side wall in the inward direction.

As is apparent from FIGS. 2, 3 and 4, the winding direction viewed from radially inward to radially outward of the strength member 12 of the first bead reinforcement strip 10 is selected in the opposite circumferential direction to the winding direction of the strength member 13 of the second bead reinforcement strip 11. In this context, in a first embodiment which is illustrated in FIGS. 2, 3 and 4, the winding direction of the strength member 13 of the second bead reinforcement strip 11 is wound from radially inward to radially outward counter to the circumferential direction “U” which is in the rotational direction when a vehicle is traveling forward with a mounted vehicle pneumatic tire. The winding direction of the strength member 12 of the first bead reinforcement strip 10 is wound radially inward to radially outward in the circumferential direction “U” which is in the rotational direction when a vehicle is traveling forward with a vehicle pneumatic tire mounted.

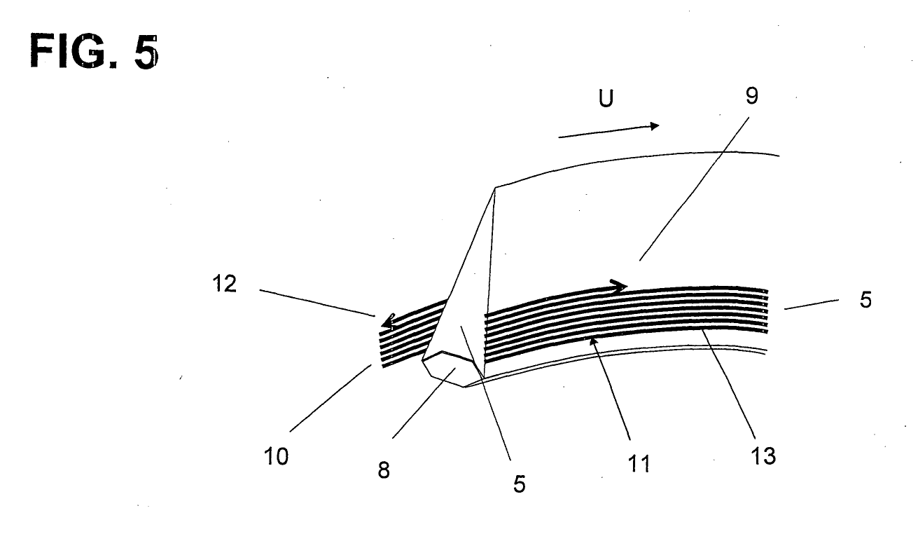

In a second embodiment is illustrated in FIG. 5, the winding direction of the strength member 12 of the first bead reinforcement strip 10 is wound from radially inward to radially outward counter to the circumferential direction “U” which is in the rotational direction when a vehicle is traveling forward with a vehicle pneumatic tire mounted. The winding direction of the strength member 13 of the second bead reinforcement strip 12 is wound from radially inward to radially outward in the circumferential direction “U” which is in the rotational direction when a vehicle traveling forward with a vehicle pneumatic tire mounted.

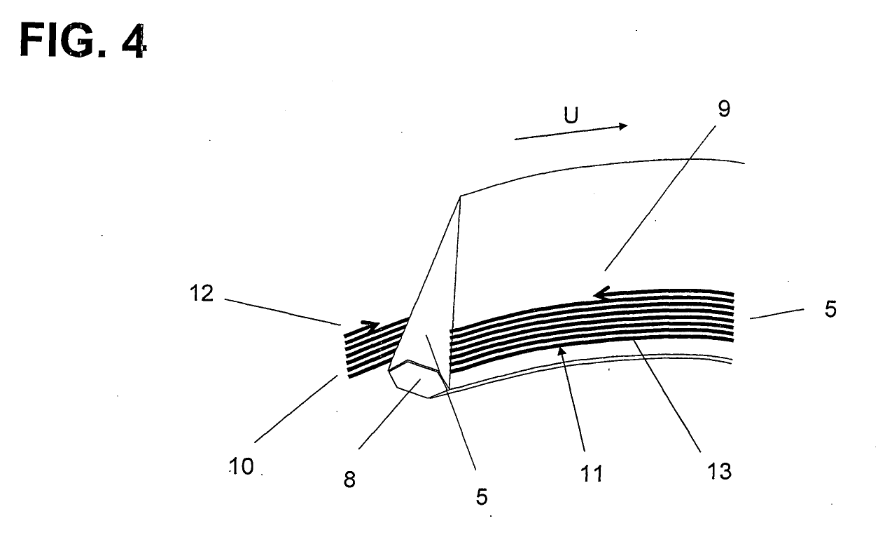

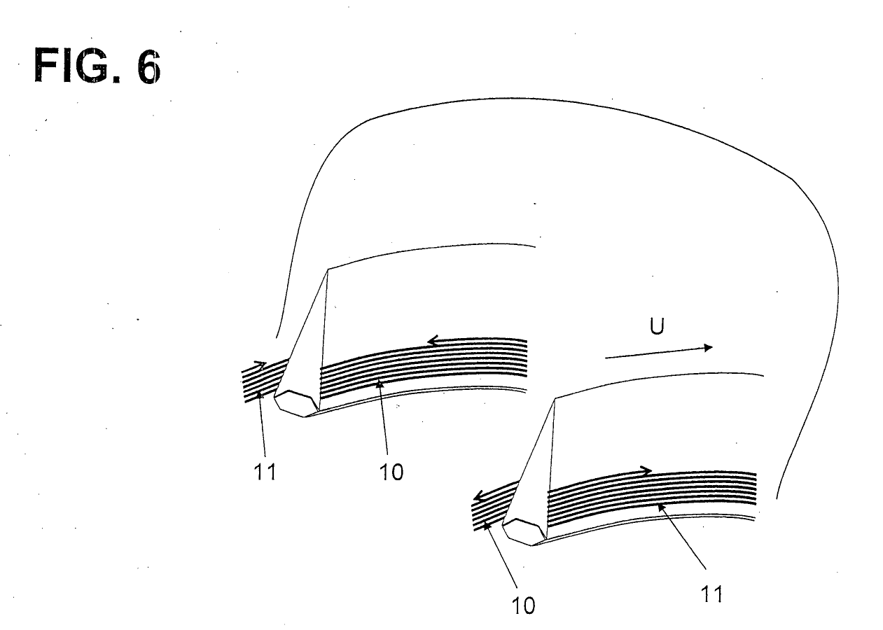

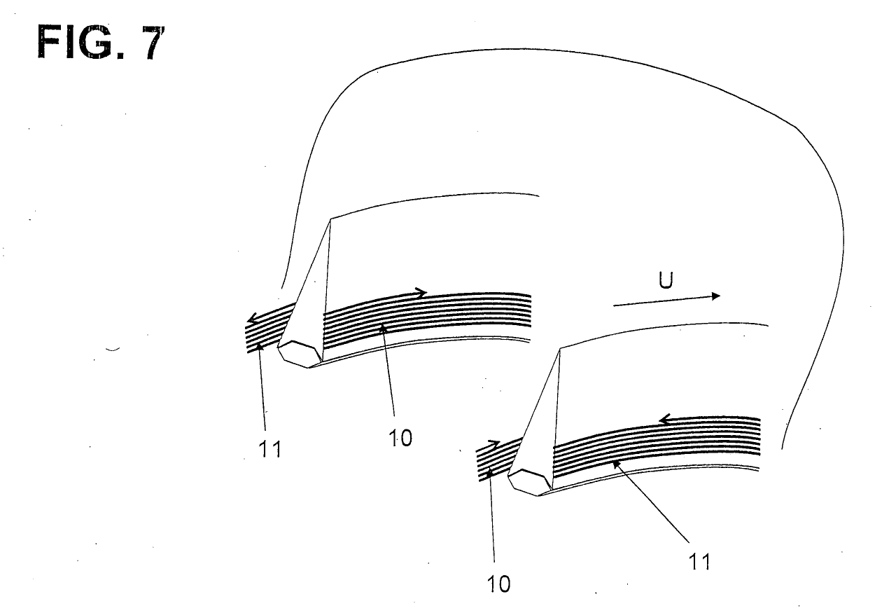

FIGS. 6 and 7 are each schematic views of an embodiment of the two bead regions of the vehicle pneumatic tire in a symmetrical embodiment. The two bead regions in the embodiment in FIG. 6 respectively correspond to the embodiment illustrated in FIG. 5. The two bead regions in the embodiment illustrated in FIG. 7 respectively correspond to the embodiment of the bead illustrated in FIG. 4.

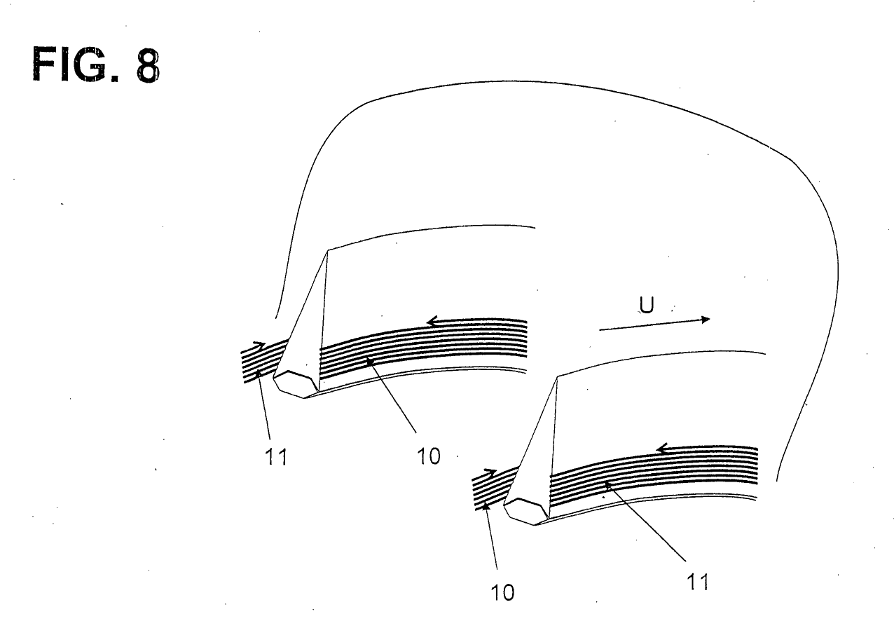

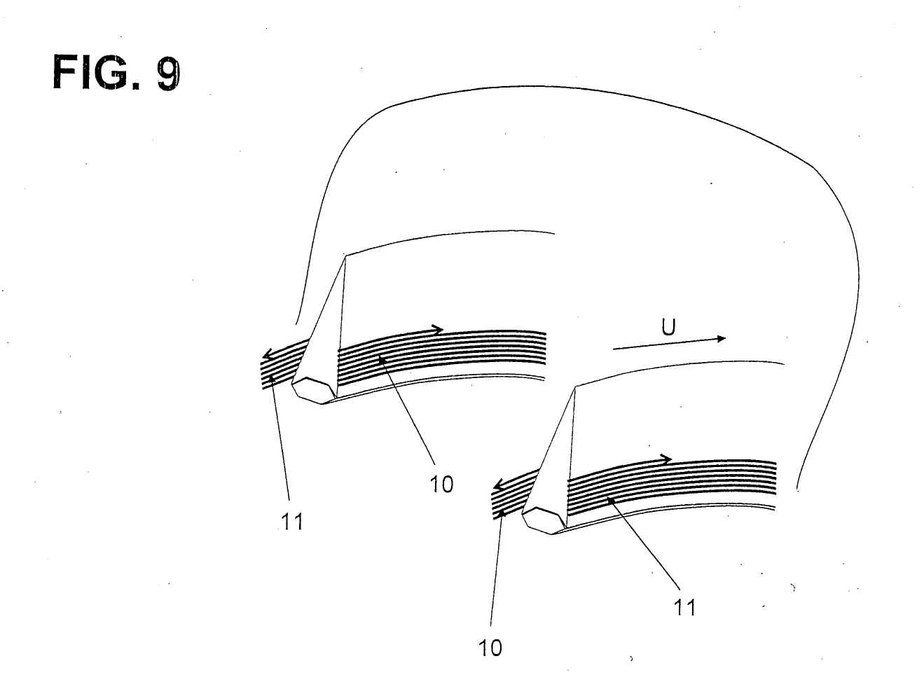

FIGS. 8 and 9 are each schematic views of an embodiment of the two bead regions of the vehicle pneumatic tire in an asymmetrical embodiment. In the embodiment in FIG. 8, the right hand bead region corresponds to the embodiment illustrated in FIG. 5, and the left hand bead region corresponds to the embodiment illustrated in FIG. 4. In the embodiment in FIG. 9, the right hand bead region corresponds to the embodiment illustrated in FIG. 4 and the left hand bead region corresponds to the embodiment illustrated in FIG. 5.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A pneumatic vehicle tire, comprising:
a tread;
two tire side walls each having one tire bead which is formed at a radially inner end;
a carcass starting from the tread and extending on both sides of the tread, the carcass comprises a main part through the tire side walls in a radially inner direction to a tire bead and folded over in the tire bead about a bead core formed so as to extend over a circumference of the pneumatic vehicle tire in order to secure a seat of the pneumatic vehicle tire on a rim, and extend radially outward with the fold in the carcass;
a first bead reinforcement material arranged on a side of the bead core axially facing the main part of the carcass between the main part of the carcass and the bead core; and
a second bead reinforcement material arranged on a side of the bead core axially facing the fold in the carcass between the fold in the carcass and the bead core,
wherein the first and the second bead reinforcement materials have strength members continuously wound in a helical shape from radially on an inside to radially on an outside in a circumferential direction and in opposing winding directions.

2. The pneumatic vehicle tire according to the features of claim 1, further comprising:
a core rider arranged on a radial outer side of the bead core and formed so as to extend in the circumferential direction of the pneumatic vehicle tire over an entire circumference of the pneumatic vehicle tire,
wherein at least one of:
the first bead reinforcement material is formed axially between the main part of the carcass and the core rider from the bead core in the radially outer direction along a surface of the core rider; and
the second bead reinforcement material is formed so as to extend axially between the fold in the carcass and the core rider from the bead core in the radially outer direction along the surface of the core rider.

3. The pneumatic vehicle tire according to the features of claim 2, wherein the fold in the carcass ends in the radially outer direction in a radial region of an extension of the core rider.

4. The pneumatic vehicle tire according to the features of claim 1, wherein the carcass is of a radial design.

5. The pneumatic vehicle tire according to the features of claim 1, wherein the carcass includes steel strength members.

6. The pneumatic vehicle tire according to the features of claim 1, wherein the strength members of the first and second bead reinforcement material are steel.

7. The pneumatic vehicle tire according to the features of claim 2, wherein the strength members of the first and second bead reinforcement material are wound directly onto a surface of at least one of the bead core and of the core rider.

8. The pneumatic vehicle tire according to the features of claim 1, wherein the strength member of the first bead reinforcement material of a first and second bead of the tire side walls have a same winding direction, and the strength member of the second bead reinforcement material of the first and second bead have a same winding direction.

9. The pneumatic vehicle tire according to the features of claim 1, wherein:
the strength member of the first bead reinforcement material of a first bead of the tire side walls and the strength member of the second bead reinforcement material of a second bead of the tire side walls have a same winding direction, and
the strength member of the second bead reinforcement material of the first bead and the strength member of the first bead reinforcement material of the second bead of the pneumatic vehicle tire have a same winding direction.

10. A pneumatic vehicle tire, comprising:
a first bead reinforcement material arranged on an inner side of a bead core; and
a second bead reinforcement material on an outer side of the bead core,
wherein the first and the second bead reinforcement materials have strength members continuously wound in a helical shape from radially on an inside to radially on an outside in a circumferential direction and in opposing winding directions.

11. The pneumatic vehicle tire according to the features of claim 10, wherein the first bead reinforcement material and the second bead reinforcement material extend over an entire circumference of the pneumatic vehicle tire.

12. The pneumatic vehicle tire according to the features of claim 10, wherein the first bead reinforcement material is formed axially between a main part of a carcass and a bead core with a bead filler.

13. The pneumatic vehicle tire according to the features of claim 12, wherein;
the first and second bead reinforcement material rest directly on a surface of the bead filler and of the bead core; and
the second bead reinforcement material is formed axially between a fold in the carcass and the bead core with the bead filler.

14. The pneumatic vehicle tire according to the features of claim 10, wherein:
the first bead reinforcement material extends starting from a radial position which corresponds to a radially outermost extension of a bead core, outward in a radial direction as far as at maximum over an entire extension of a side wall in an outward direction, and inward in the radial direction as far as at maximum over an entire extension of the side wall in the inward direction; and
the second bead reinforcement tire extends outward in the radial direction starting from the radial position, corresponding to the radially outermost extension of the bead core, in the radial direction as far as at maximum over the entire extension of the side wall in the outward direction, and inward in the radial direction as far as at maximum over the entire extension of the side wall in the inward direction.

15. The pneumatic vehicle tire according to the features of claim 10, wherein a winding direction viewed from radially inward to radially outward of the strength member of the first bead reinforcement material is selected in an opposite circumferential direction to a winding direction of the strength member of the second bead reinforcement material.

16. The pneumatic vehicle tire according to the features of claim 10, wherein:
a winding direction of the strength member of the second bead reinforcement material Is wound from radially inward to radially outward counter to a circumferential direction “U” which is in a rotational direction when a vehicle is traveling forward with a mounted vehicle pneumatic tire; and
a winding direction of the strength member of the first bead reinforcement material is wound radially inward to radially outward in the circumferential direction “U” which is in the rotational direction when the vehicle is traveling forward.

17. The pneumatic vehicle tire according to the features of claim 10, wherein the strength members are metallic embedded in rubber and constructed from one of a monofilament and a multifilament.

18. The pneumatic vehicle tire according to the features of claim 10, wherein:
a winding direction of the strength member of the first bead reinforcement strip is wound from radially inward to radially outward counter to a circumferential direction “U” which is in a rotational direction when a vehicle is traveling forward with a vehicle pneumatic tire mounted, and
a winding direction of the strength member of the second bead reinforcement strip is wound from radially inward to radially outward in the circumferential direction “U” which is in the rotational direction when the vehicle traveling forward.

19. A method of manufacturing pneumatic a vehicle tire, comprising:
continuously winding strength members of a first bead reinforcement material on a side of a bead core axially facing a main part of a carcass and between the main part of the carcass and the bead core in a helical shape from radially on an inside to radially on an outside in a circumferential direction in a first direction; and
continuously winding strength members of a second bead reinforcement material arranged on a side of the bead core axially facing a fold in the carcass and between the fold in the carcass and the bead core in a helical shape from radially on an inside to radially on an outside in a circumferential direction and in an opposing direction to the first direction.
